(19) United States
(12) Patent Application Publication
(10) Pub. No.: US 2020/0196030 A1
(43) Pub. Date: Jun. 18, 2020

(54) METER MONITORING DEVICE AND CONTROL METHOD THEREOF

(71) Applicant: Chicony Electronics Co., Ltd., New Taipei City (TW)

(72) Inventor: Tung-Sheng CHIU, New Taipei City (TW)

(21) Appl. No.: 16/547,603

(22) Filed: Aug. 22, 2019

(30) Foreign Application Priority Data
Dec. 12, 2018 (TW) 107144852

(51) Int. Cl. H04Q 9/02

(52) U.S. Cl. CPC H04Q 9/02; H04Q 2213/1308; H04Q 2209/883

(57) ABSTRACT

The meter monitoring device includes a housing, a power supply unit, an image capture unit, a control unit, a first switch, and a clock unit. The housing is configured to be detachably attached to a meter device. The image capture unit is electrically connected to the power supply unit. The control unit is configured to control the image capture unit to capture an image of a surface of the meter device. The first switch is connected between the power supply unit and the control unit. The power supply unit is configured to supply electrical power to the control unit via the first switch. The clock unit is configured to control the first switch to be turned on according to a setting. The power supply unit, the control unit, the image capture unit, the first switch, and the clock unit are all fixed to the housing.

### CROSS-REFERENCE TO RELATED APPLICATION

This application claims priority to Taiwan Application Serial Number 107144852, filed Dec. 12, 2018, which is herein incorporated by reference in its entirety.

### BACKGROUND

### Field of Invention

The present invention relates to a meter monitoring device and a control method of the meter monitoring device. More particularly, the present invention relates to an energy-saving meter monitoring device which is mounted outside a meter device and a control method of the meter monitoring device.

### Description of Related Art

Conventionally, a numeric value shown on a meter device such as a water meter, an electric meter or a gas meter has to be read by a staff of a related company, so as to know a household's utility usage. In the age of IoT (Internet of Things), although a smart meter device, such as a smart water meter, a smart electricity meter or a smart gas meter, has been presented to the market, yet it is expensive and difficult to replace an originally-implemented water meter, electricity meter or gas meter with the smart meter device. Thus, the replacement is almost infeasible.

In addition, the smart meter device usually only performs a function of transferring data or storing data within a predetermined period of time, such that the smart meter device is at an idle state in the other periods of time. However, when being at the idle state, a power unit of the smart meter device still supplies electrical power to the functional elements of the smart meter device continuously, thus resulting in wasting electric power. Moreover, the communication setting of the smart meter device may not meet user's current needs after a period of time, and need to be updated.

Accordingly, how to provide a meter monitoring device which may auto-updates its communication setting and is energy saving and applicable to various meter devices on the market becomes an important issue to be resolved by those in the industry.

### SUMMARY

The invention provides a meter monitoring device which is capable of effectively saving power and auto-updating its communication settings, and is applicable to various meter devices. The invention also provides a control method of the meter monitoring device.

According to an embodiment of the disclosure, the meter monitoring device includes a housing, a power supply unit, an image capture unit, a control unit, a first switch, and a clock unit. The housing is configured to be detachably attached to a meter device. The image capture unit is electrically connected to the power supply unit. The control unit is configured to control the image capture unit to capture an image of a surface of the meter device. The first switch is connected between the power supply unit and the control unit. The power supply unit is configured to supply power to the control unit via the first switch. The clock unit is configured to control the first switch to be turned on according to a setting. The power supply unit, the control unit, the image capture unit, the first switch, and the clock unit are all fixed to the housing.

In an embodiment of the disclosure, the meter monitoring device further includes a second switch. The control unit is configured to control the second switch to be turned on or turned off. The power supply unit is configured to supply power to the image capture unit via the second switch.

In an embodiment of the disclosure, the meter monitoring device further includes a communication unit electrically connected to the control unit and the power supply unit. The communication unit is configured to transmit information to an external device.

In an embodiment of the disclosure, the meter monitoring device further includes a second switch. The control unit is configured to control the second switch to be turned on or turned off. The power supply unit is configured to supply power to the communication unit via the second switch.

In an embodiment of the disclosure, the meter monitoring device further includes a main board. The main board includes fixed connection sockets. The image capture unit includes a connection plug. The connection plug is detachably connected to one of the fixed connection sockets.

In an embodiment of the disclosure, the meter monitoring device further includes an image identification unit. The image identification unit is electrically connected to the image capture unit. The image identification unit is configured to identify a character in the image.

In an embodiment of the disclosure, the control unit is configured to control the clock unit to turn off the first switch.

According to an embodiment of the disclosure, a control method for controlling a meter monitoring device attached on a meter device is provided. The meter monitoring device includes a power supply unit, a control unit, a first switch connected between the power supply unit and the control unit, an image capture unit connected to the control unit, and a clock unit connected to the first switch. The control method includes enabling the clock unit to turn on the first switch according to a first setting, so as to allow the power supply unit to supply power to the control unit via the first switch, and enabling the control unit to control the image capture unit to capture an image of a surface of the meter device.

In an embodiment of the disclosure, the meter monitoring device further includes a second switch. The second switch is connected between the power supply unit and the image capture unit. The control method further includes enabling the control unit to turn on the second switch, so as to allow the power supply unit to supply power to the image capture unit via the second switch.

In an embodiment of the disclosure, the meter monitoring device further includes a communication unit. The communication unit is connected to the control unit and the power supply unit. The control method further includes enabling the control unit to control the communication unit to transmit information to an external device.

In an embodiment of the disclosure, the meter monitoring device further includes a second switch. The second switch is connected between the power supply unit and the communication unit. The control method further includes enabling the control unit to turn on the second switch, so as to allow the power supply unit to supply power to the communication unit via the second switch.

In an embodiment of the disclosure, the method further includes enabling the communication unit to receive a second setting from the external device, and enabling the control unit to update the clock unit according to the second setting, so as to enable the clock unit to turn on the first switch according to the second setting.

In an embodiment of the disclosure, the method further includes after updating the clock unit according to the second setting, enabling the control unit to control the clock unit to turn off the first switch, so as to stop the power supply unit from supplying power to the control unit.

In an embodiment of the disclosure, the meter monitoring device further includes an image identification unit. The image identification unit is connected to the image capture unit. The control method further includes enabling the image identification unit to identify a character in the image.

Accordingly, in the meter monitoring device and the control method thereof of the present disclosure, one or more switches are disposed between the power supply unit and either of the control unit, the image capture unit and the communication unit. With the aforementioned configuration, the specific switch is turned on when it is necessary to allow the power unit to supply electrical power to the specific functional unit, thereby achieving the purpose of electrical power saving. In addition, the meter monitoring device of the present disclosure is detachably attached to the meter devices with various specifications on the market without needing to replace the original meter device, thus avoiding complicated replacement work and greatly saving replacement cost. Furthermore, the meter monitoring device of the present disclosure is able to automatically retrieve new settings from a remote end and automatically update its settings according to the new settings, so as to meeting the user's needs.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a meter monitoring device attached on a meter device according to an embodiment of the present disclosure;

FIG. 2 is a functional block diagram of the meter monitoring device according to an embodiment of the present disclosure;

FIG. 3 is a schematic diagram showing an image capture unit connected to a main board in the meter monitoring device according to an embodiment of the present disclosure;

FIG. 4 is a schematic diagram of an image of a surface of the meter device captured by the meter monitoring device according to an embodiment of the present disclosure;

FIG. 5 is a schematic diagram showing the meter monitoring device connected to an external device according to an embodiment of the present disclosure;

FIG. 6 is a flow chart showing a method for controlling the meter monitoring device in an operation mode according to an embodiment of the present disclosure;

FIG. 7 is a flow chart showing a method for controlling the meter monitoring device in the operation mode according to another embodiment of the present disclosure;

FIG. 8 is a flow chart showing a method for controlling the meter monitoring device in the operation mode according to another embodiment of the present disclosure; and

FIG. 9 is a flow chart showing a method for controlling the meter monitoring device in an update mode according to an embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

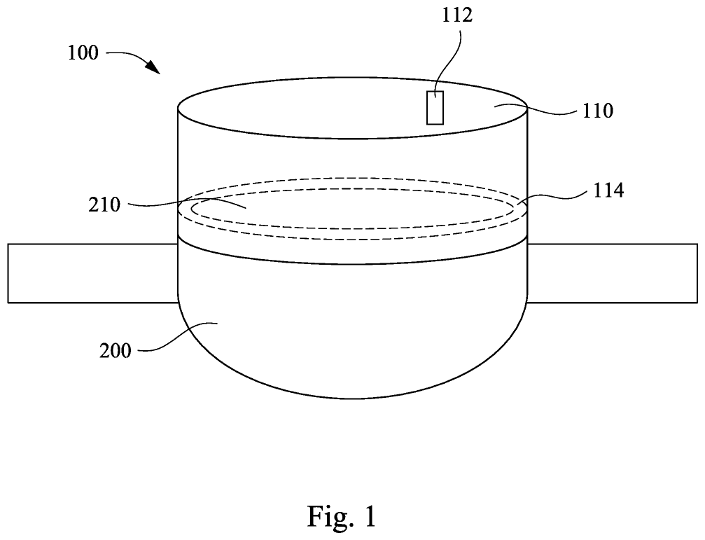

Reference is made to FIG. 1. FIG. 1 is a perspective view of a meter monitoring device 100 attached on a meter device 200 according to an embodiment of the present disclosure. The meter monitoring device 100 includes a housing 110. The housing 110 is detachably attached to a meter device 200. Thus, a user is able to manually disassemble the meter monitoring device 100 and install the meter monitoring device 100 on various types of meter devices on the market. For example, the meter device 200 of the present disclosure can be a meter that is used to measure the usage of energy or substance, such as a water meter, an electric meter, or a gas meter. The disclosure should not be limited in this regard. The housing 110 includes a viewing window 112 and a waterproof ring 114. The viewing window 112 is disposed on the housing 110 and opposite to a surface 210 of the meter device 200. Specifically, the viewing window 112 is a slot in which a transparent material (for example, glass) is embedded. A user can inspect the data shown on the surface 210 through the viewing window 112 without disassembling the housing 110. The waterproof ring 114 is disposed at a junction between the housing 110 and the meter device 200 to prevent water or moisture from entering the meter monitoring device 100 or the meter device 200 from the junction between the housing 110 and the meter device 200, thus preventing the meter monitoring device 100 or the meter device 200 from malfunctioning.

In some embodiments, the viewing window 112 is externally implemented with a liftable cover to prevent dust and rain from entering the housing 110 via the viewing window 112. In some embodiments, the position of the viewing window 112 is flexibly adjusted according to actual needs. The disclosure should not be limited to FIG. 1. In other embodiments, the viewing window 112 is dispensable, but the disclosure should not be limited in this regard.

In some embodiments, the waterproof ring 114 may be a silicon ring, a rubber ring, or an O-ring, but the disclosure should not be limited in this regard. In some embodiments, the waterproof ring 114 is dispensable.

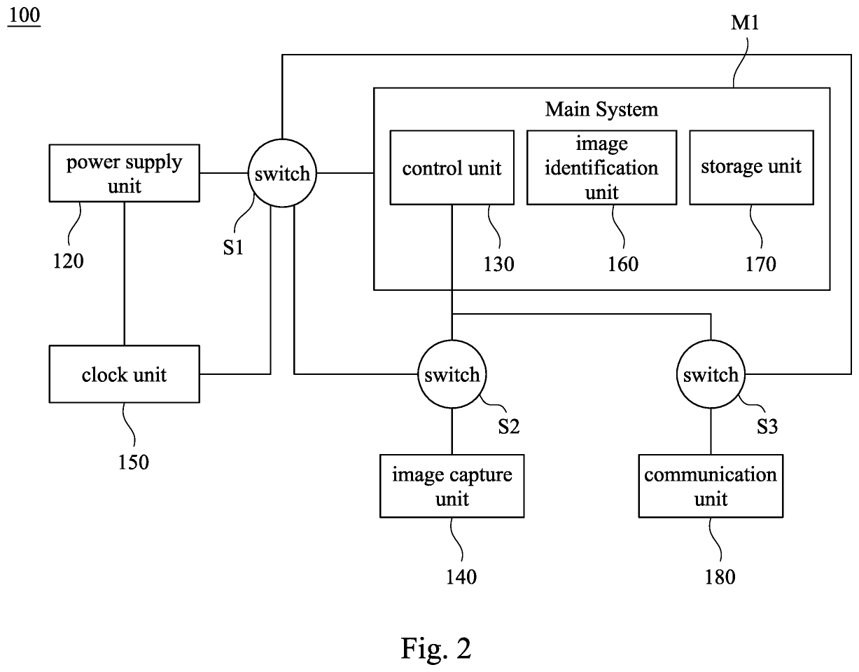

Reference is made to FIG. 2. FIG. 2 is a functional block diagram of the meter monitoring device 100 according to an embodiment of the present disclosure. As shown in FIG. 2, the meter monitoring device 100 further includes a power supply unit 120, a control unit 130, an image capture unit 140, a clock unit 150, an image identification unit 160, a storage unit 170, a communication unit 180, a first switch S1, a second switch S2, and a third switch S3. The power supply unit 120, the control unit 130, the image capture unit 140, the clock unit 150, the image identification unit 160, the storage unit 170, the communication unit 180, the first switch S1, the second switch S2, and the third switch S3 are all fixed to the housing 110. In the embodiment, the control unit 130, the image identification unit 160 and the storage unit 170 are integrated on a mother board to form a main system M1, but the disclosure should not be limited in this regard. In some embodiments, the control unit 130, the image identification unit 160 and the storage unit 170 are independent function units respectively.

The first switch S1 is connected between the main system M1 and the power supply unit 120. The second switch S2 is connected between the control unit 130 and the image capture unit 140. The third switch S3 is connected between the control unit 130 and the communication unit 180. The second switch S2 and the third switch S3 are further connected to the power supply unit 120 via the first switch S1. The power supply unit 120 is electrically connected to the clock unit 150. The power supply unit 120 is configured to supply electrical power to the clock unit 150. The clock unit 150 is configured to turn on the first switch S1 according to a first setting. In some embodiments, the setting information in the first setting includes time and date, OCR identification information (such as ROI quantity, position, font type, and so on) and communication information (such as, the transmission period of the recognized character and/or the period for the communication unit 180 to receive the new setting), but the disclosure should not be limited in this regard. Accordingly, the power supply unit 120 supplies electrical power to the control unit 130, the image identification unit 160 and the storage unit 170 in the main system M1 via the first switch S1. Further, the control unit 130 is configured to control the second switch S2 and the third switch S3 to be turned on or turned off, such that the power supply unit 120 is able to supply electrical power to the image capture unit 140 via the first switch S1 and the second switch S2, or the power supply unit 120 is able to supply electrical power to the communication unit 180 via the first switch S1 and the third switch S3.

In some embodiments, the second switch S2 and the third switch S3 collectively can be replaced by a fourth switch. In other words, the image capture unit 140 and the communication unit 180 are connected to the control unit 130 via the fourth switch. Further, the fourth switch is connected to the power supply unit 120 via the first switch S1. Accordingly, the control unit 130 is configured to control the fourth switch to be turned on or turned off, such that the power supply unit 120 is able to supply electrical power to the image capture unit 140 and the communication unit 180 at the same time via the first switch S1 and the fourth switch. In another embodiment, one or two of the first switch S1, the second switch S2 and the third switch S3 is/are dispensable in the meter monitoring device 100. The disclosure should not be limited in this regard.

In some embodiments, the power supply unit 120 may be a battery, a power supply circuit, but the disclosure should not be limited in this regard.

In some embodiments, the image capture unit 140 may be a camera or a photographing device adopting a charge-coupled device (CCD) or a complementary metal-oxide-semiconductor (CMOS) as a photosensitive element. The disclosure should not be limited in this regard.

In some embodiments, the storage unit 170 may be a flash memory or a random access memory, but the disclosure should not be limited in this regard.

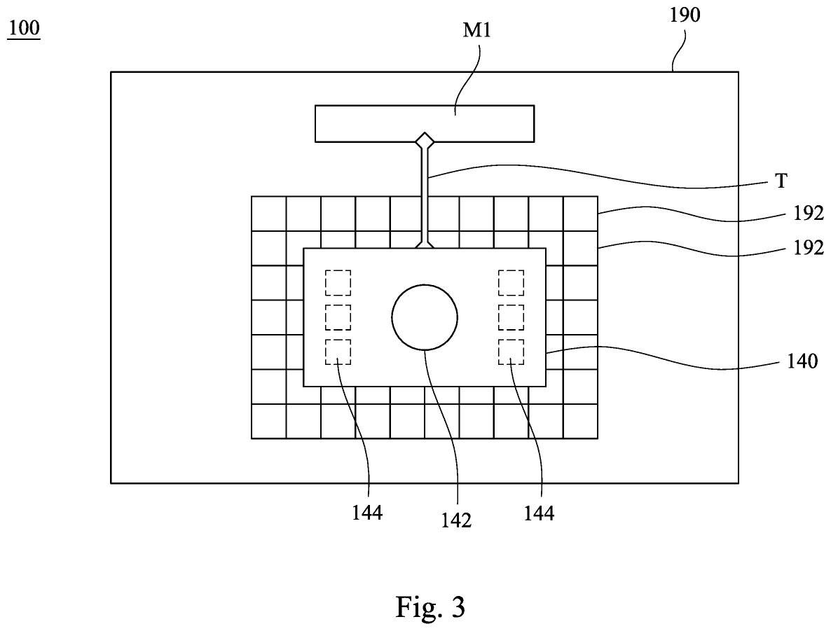

Reference is made to FIG. 3. FIG. 3 is a schematic diagram showing an image capture unit 140 connected a main board 190 in the meter monitoring device 100 according to an embodiment of the present disclosure. As shown in FIG. 3, the meter monitoring device 100 further includes a main board 190. The main system M1 is disposed on the main board 190, but the disclosure should not be limited in this regard. The main board 190 includes plural fixed connection sockets 192. The fixed connection sockets 192 are arranged on the main board 190 and form a matrix (for example, a matrix of 7×10), but the disclosure should not be limited in this regard. The image capture unit 140 includes a lens 142 and six connection plugs 144. The lens 142 is opposite to the surface 210 of the meter device 200 to capture an image of the surface 210. The connection plugs 144 are disposed on a side of the image capture unit 140 opposite to the lens 142. The connection plugs 144 are pluggably connected to one or more fixed connection sockets 192 of the fixed connection sockets matrix, according to the number of the connection plugs 144. Accordingly, the relative position of the image capture unit 140 on the surface 210 is adjustable by adjusting the connection position between the connection plug 144 and the main board 190, thereby enabling the image capture unit 140 of the meter monitoring device 100 of the present disclosure to conform to the different meter devices 200 on the market with various specifications and arrangements of the surfaces.

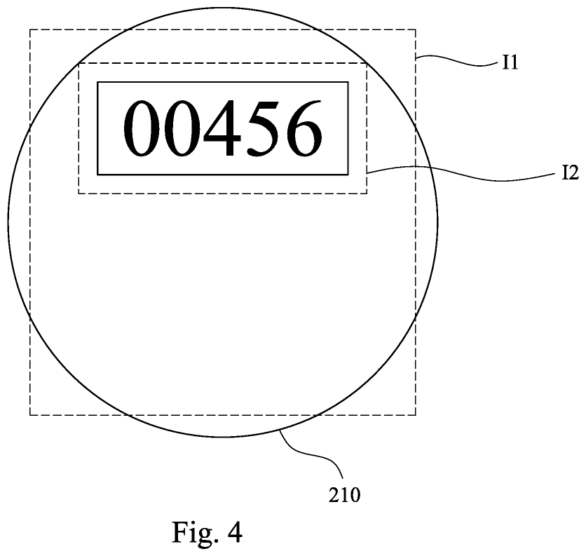

Moreover, in the embodiment, each of the connection plugs 144 is a foot pin, but the disclosure should not be limited in this regard. The length of the foot pin is determined by the focal length of the lens 142. A distance between the image capture unit 140 and the surface 210 is adjusted by selecting a foot pin with an appropriate length. As such, the image capture unit 140 can clearly capture the images of the surfaces 210 (as shown in FIG. 4) of the various meter devices 200 (such as a water meter, an electric meter, a gas meter and so on) on the market. The image capture unit 140 is electrically connected to the image identification unit 160 and the storage unit 170 in the main system M1 via the connection wire T. As such, the images of the surface 210 captured by the image capture unit 140 are transmitted to the image identification unit 160 or the storage unit 170 in the main system M1 via the connection wire T.

In some embodiments, the numbers and the positions of the fixed connection sockets 192 and the connection plugs 144 are flexibly adjusted according to actual needs. The disclosure should not be limited in FIG. 3.

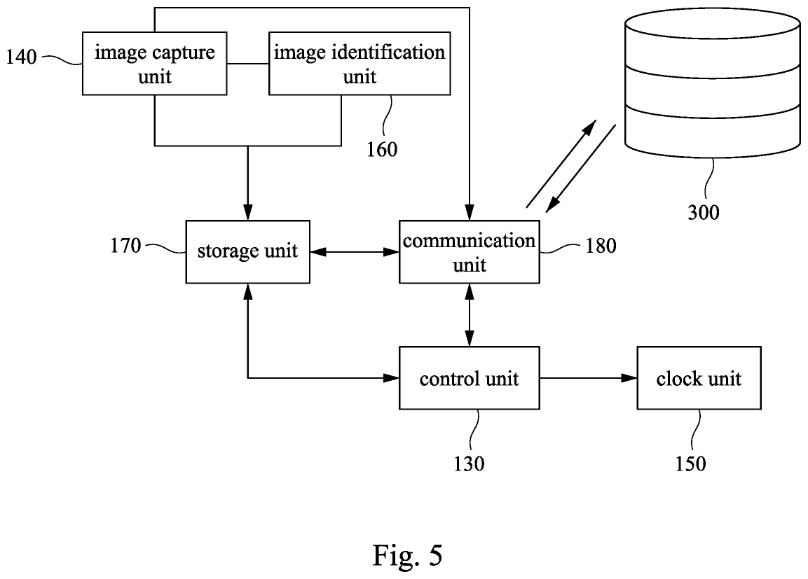

Reference is made to FIGS. 4 and 5. FIG. 4 is a schematic diagram of an image of the surface 210 of the meter device 200 captured by the meter monitoring device 100 according to an embodiment of the present disclosure. FIG. 5 is a schematic diagram showing the meter monitoring device 100 connected to an external device 300 according to an embodiment of the present disclosure. As shown in FIG. 4, the range enclosed by the dashed block 11 is an image range of the surface 210 which can be captured by the image capture unit 140. After the image capture unit 140 captures the image of the surface 210, the image is transmitted to the image identification unit 160 in the main system M1. The image identification unit 160 includes positioning information, such as a region of interest (ROI). The image identification unit 160 locates a range of characters on the surface 210, such as the range enclosed by the block 12 in FIG. 4, with the help of positioning information. After the range of the characters is located by the image identification unit 160, the image identification unit 160 recognizes the characters in the image by a software identification method, such as optical character recognition (OCR), but the disclosure should not be limited in this regard. The data of the recognized characters are further stored in the storage unit 170. When the communication unit 180 is powered by the power supply unit 120, the data of the recognized characters is transmitted to an external device 300 on a remote end via the communication unit 180.

In some embodiments, the images captured by the image capture unit 140 are stored in the storage unit 170 without undergoing an identification procedure. In the embodiment, the images captured by the image capture unit 140 are transmitted to the external device 300 via the communication unit 180, and then the image processing system in the external device 300 identifies the characters in the images. In other words, in the embodiment, the image identification unit 160 in the meter monitoring device 100 is dispensable. As such, the electrical power of the power supply unit 120 can be effectively saved and the power saving effect is enhanced.

In some embodiments, the range captured by the image capture unit 140 and the identification range of the image identification unit 160 are flexibly adjusted according to actual needs. The disclosure should not be limited in this regard.

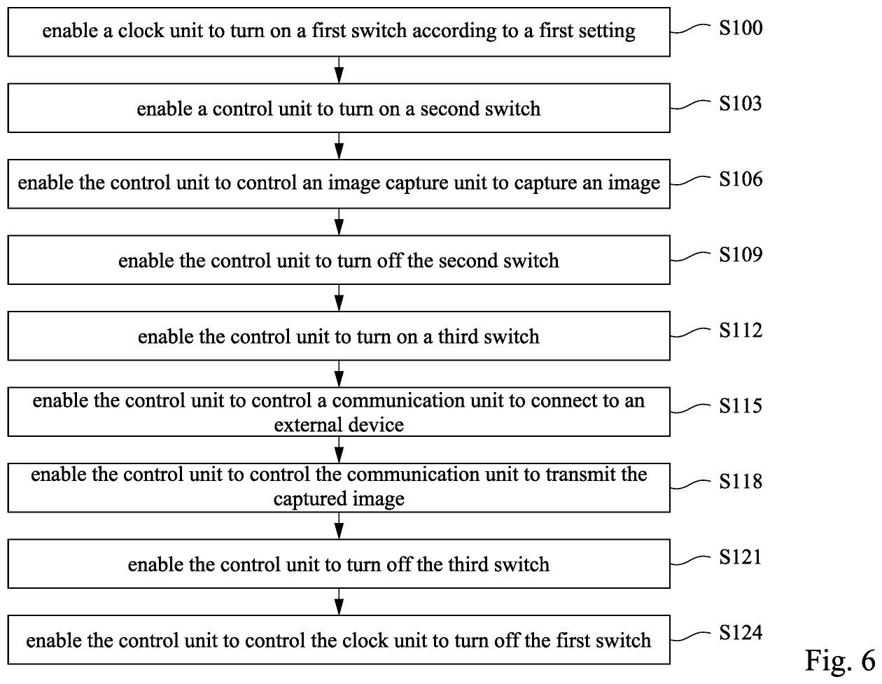

Reference is made to FIG. 6. FIG. 6 is a flow chart showing a method for controlling the meter monitoring device 100 in an operation mode according to an embodiment of the present disclosure. As shown in FIG. 6, in the embodiment, the control method for controlling the meter monitoring device 100 includes steps S100-S124. Hereinafter, the control method of the meter monitoring device 100 of the present disclosure will be exemplarily described with reference to the meter monitoring device 100 shown in FIGS. 2 and 5.

In step S100, the clock unit 150 is enabled to turn on a first switch S1 according to a first setting. In the embodiment, the clock unit 150 turns on the first switch S1 according to a first setting at a predetermined time (for example, a first time), such that the power supply unit 120 supplies electrical power to the main system M1.

In step S103, the control unit 130 is enabled to turn on a second switch S2. After the control unit 130 is powered on, the control unit 130 controls the second switch S2 to be turned on, such that the power supply unit 120 supplies electrical power to the image capture unit 140.

In step S106, the control unit 130 is enabled to control the image capture unit 140 to capture the image of the surface 210 of the meter device 200. After the second switch S2 is turned on, the image capture unit 140 is powered on by the power supply unit 120. The control unit 130 controls the image capture unit 140 to capture the image of the surface 210 of the meter device 200.

In step S109, the control unit 130 is enabled to control the second switch S2 to be turned off. After the image capture unit 140 captures the image of the surface 210, the image capture unit 140 is in an idle state. At this time, the control unit 130 controls the second switch S2 to be turned off to stop the power supply unit 120 from supplying electrical power to the image capture unit 140. Accordingly, when the image capture unit 140 is in the idle state, the power supply unit 120 does not keep supplying electrical power to the image capture unit 140, thereby preventing the unnecessary waste of the electrical power.

In step S112, the control unit 130 is enabled to control the third switch S3 to be turned on. In the embodiment, the control unit 130 controls the third switch S3 to be turned on, such that the power supply unit 120 supplies electrical power to the communication unit 180 via the first switch S1 and the third switch S3, thereby enabling the communication unit 180 to perform the communication function.

In step S115, the control unit 130 is enabled to control the communication unit 180 to connect to the external device 300. In the embodiment, the communication unit 180 connects to the external device 300, and thus the communication unit 180 is able to transmit data and information to the external device 300. In some embodiments, the communication unit 180 is connected to the external device 300 by wired communication such as optical fiber communication and cable communication, but the disclosure should not be limited in this regard. In other embodiments, the communication unit 180 is connected to the external device 300 by wireless communication such as LoRa of Low Power WAN (LPWAN), Sigfox, NB-loT, LTE-M, Wi-Fi, Bluetooth, and so on, but the disclosure should not be limited in this regard.

In step S118, the control unit 130 is enabled to control the communication unit 180 to transmit the captured image. In the embodiment, the image of the surface 210 captured by the image capture unit 140 is transmitted to the external device 300 by the communication unit 180. Accordingly, the user is able to monitor the information shown on the surface 210 by using the external device 300 at the remote end without needing to monitor the meter device 200 in person at the location of the meter device 200.

In step S121, the control unit 130 is enabled to control the third switch S3 to be turned off. After the communication unit 180 transmits the captured images to the external device 300, the communication unit 180 is in an idle state. At this time, the control unit 130 controls the third switch S3 to be turned off to stop the power supply unit 120 from supplying electrical power to the communication unit 180. Accordingly, the electrical power of the power supply unit 120 can be greatly saved.

In step S124, the control unit is enabled to control the clock unit 150 to turn off the first switch S1. After the image capture unit 140 captures the image of the surface 210 and the image is transmitted to the external device 300, the control unit 130 controls the clock units 150 to turn off the first switch S1 to stop the power supply unit 120 from supplying electrical power to the main system M1. Accordingly, the power supply unit 120 stops supplying electrical power to the control unit 130 to save electrical power as the control unit 130 is in an idle state.

In some embodiments, step S109 can be implemented after step S115, step S118, or step S121. The disclosure should not be limited in this regard.

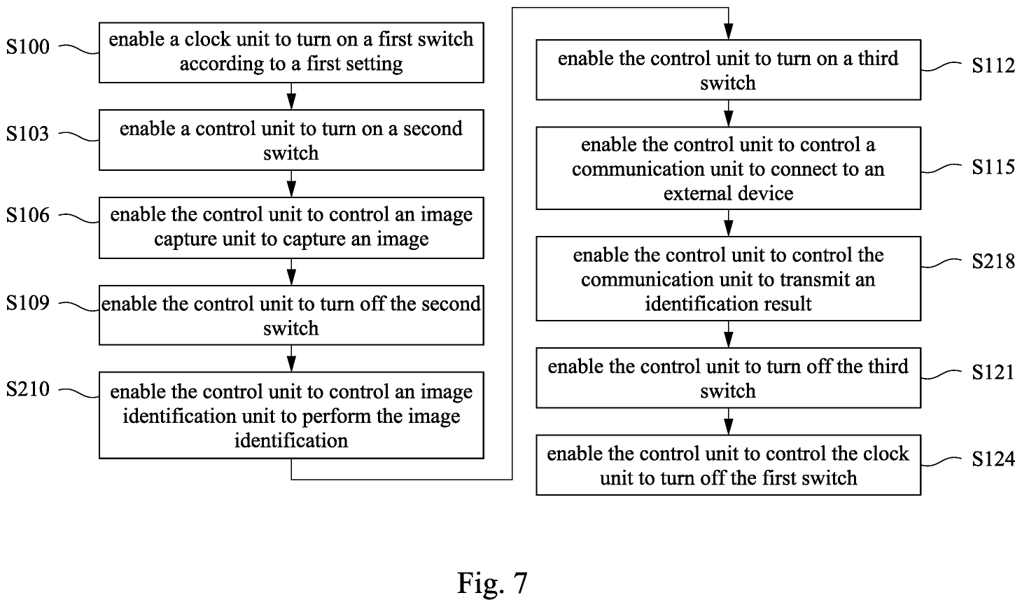

Reference is made to FIG. 7. FIG. 7 is a flow chart showing a method for controlling the meter monitoring device 100 in the operation mode according to another embodiment of the present disclosure. Steps S100-S109, steps S112-S115, and steps S121-S124 of the method in FIG. 7 are similar to those described above with respect to steps S100-S109, steps S112-S115, and steps S121-S124 of the method in FIG. 6, and thus are not described again for the sake of brevity. The method in FIG. 7 is different from the method in FIG. 6 in that method in FIG. 7 further includes step S210 after step S109, and step S118 of the method in FIG. 6 is replaced by step S118 of the method in FIG. 7.

In step S210, the control unit 130 is enabled to control the image identification unit 160 to perform the image identification procedure. In the embodiment, after the image capture unit 140 captures the image, the image capture unit 140 transmits the captured image to the image identification unit 160. After the image identification unit 160 receives the image from the image capture unit 140, the control unit 130 controls the image identification unit 160 to identify the characters in the image. In some embodiments, the character can be a string of number, such as 0-999, but the disclosure should not be limited in this regard.

In step S218, the control unit 130 is enabled to control the communication unit 180 to transmit an identification result. After the image identification unit 160 identifies the character in the image, the identification result is transmitted to the communication unit 180 which is connected to the external device 300, and then the communication unit 180 transmits the identification result to the external device 300. As such, the external device 300 receives the digital data of the image of the surface 210 instead of the image data.

In some embodiments, step S210 can be implemented after step S106. The disclosure should not be limited in this regard.

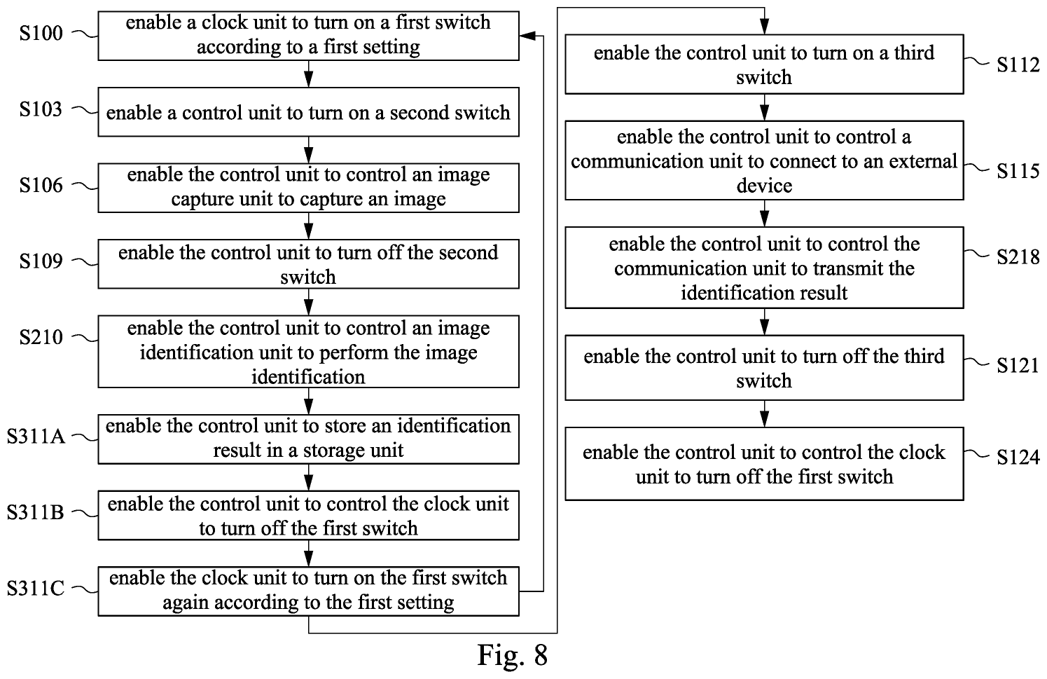

Reference is made to FIG. 8. FIG. 8 is a flow chart showing a method for controlling the meter monitoring device 100 in the operation mode according to another embodiment of the present disclosure. Steps S100-S109, step S210, steps S112-S115, step S218, and steps S121-S124 of the method in FIG. 8 are similar to those described above with respect to steps S100-S109, step S210, steps S112-S115, step S218, and steps S121-S124 of the method in FIG. 7, and thus are not described again for the sake of brevity. The method in FIG. 8 is different from the method in FIG. 7 in that method in FIG. 8 further includes steps S311A-S311C after step S210.

In step S311A, the control unit is enabled to store the identification result in the storage unit 170. In the embodiment, after the image identification unit 160 identifies the character in the image captured by the image capture unit 140, the control unit 130 controls the identification result to be stored in the storage unit 170.

In some embodiments, step S109 can be implemented after step S311A. The disclosure should not be limited in this regard.

In step S311B, the control unit 130 is enabled to control the clock unit 150 to turn off the first switch S1. In the embodiment, the meter monitoring device 100 acquires the digital data of the surface 210 of the meter device 200 by using the image capture unit 140, and the digital data of the surface 210 is stored in the storage unit 170. At this time, the control unit 130 controls the clock unit 150 to turn off the first switch S1 to save electrical power.

In step S311C, the clock unit 150 is enabled to turn on the first switch S1 again according to the first setting. After a period of idle time, the meter monitoring device 100 needs to perform the meter monitoring function again. Therefore, the clock unit 150 turns on the first switch S1 again according to the first setting at another predetermined time (for example, the second time) to restore the electrical conduction between the power supply unit 120 and the main system M1. Then, steps S112-S115, step S218, steps S121-S124 are implemented after the main system M1 is powered on.

In some embodiments, steps S100-S311B can be re-implemented after step S311C until the storage capacity of the storage unit 170 reaches a limit. Then, steps S112-S115, step S218, steps S121-S124 are implemented.

In some embodiments, step S210 can be optionally omitted, and step S118 is used to replace step S218. In the embodiment, after the image capture unit 140 captures the image of the surface 210, the captured image is directly transmitted to the storage unit 170 for storage. That is, the image identification unit 160 does not need to perform the image identification function, thereby eliminating electrical power consumption during the image identification to greatly save the electrical power.

In the embodiment shown in FIG. 8, the time at which the image capture unit 140 captures the image is different from the time at which the communication unit 180 uploads the data. Fox example, the image capture unit 140 captures the image every hour, but the communication unit 180 uploads the image or the identification result once a day. Accordingly, the image capture unit 140 and the image identification unit 160 are allowed to store the captured image and the identification result in the storage unit temporarily. When the communication unit 180 is connected to the external device 300, the captured image and the identification result are uploaded to the external device 300 by the communication unit 180.

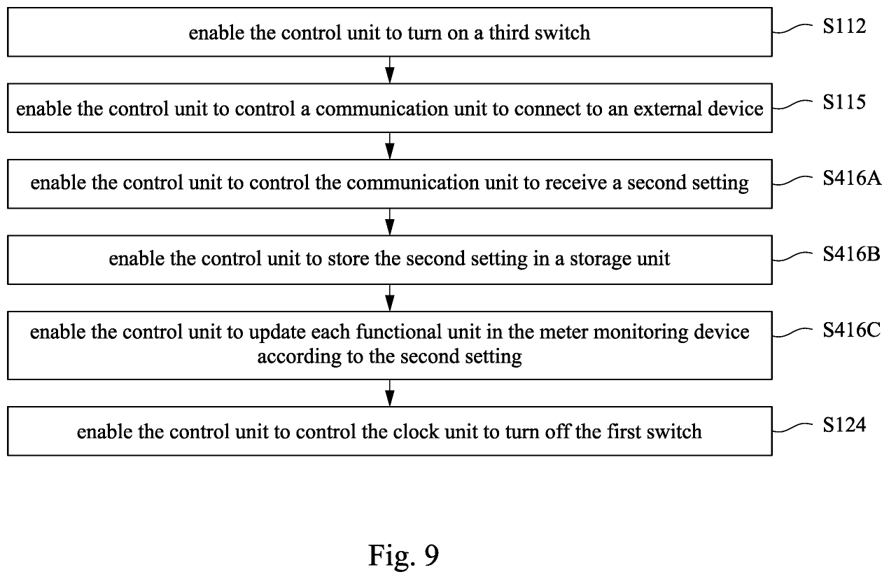

Reference is made to FIG. 9. FIG. 9 is a flow chart showing a method for controlling the meter monitoring device 100 on an update mode according to an embodiment of the present disclosure. In some embodiments, besides the operation mode, the meter monitoring device 100 further includes the update mode. When the meter monitoring device 100 is in the update mode, steps S416A-S416C are performed after step S115. Step S112, step S115, and step S124 of method in FIG. 9 are similar to those described above with respect to step S112, step S115, and step S124 of method in FIG. 6, and thus are not described again for the sake of brevity.

In step S416A, the control unit 130 is enabled to control the communication unit 180 to receive a second setting. In the embodiment, after the communication unit 180 is connected to the external device 300, the communication unit 180 receives a second setting from the external device 300, and transmits the second setting to the control unit 130.

The setting information in the second setting is similar to that described above with respect to the setting information in the first setting, and thus is not described again for the sake of brevity. The second setting is different from the first setting in that the information content of the second setting is different from the information content of the first setting. For example, the second setting is a new version of the first setting, but the disclosure should not be limited in this regard.

In step S416B, the control unit 130 is enabled to store the second setting in the storage unit 170. In the embodiment, after the control unit 130 receives the second setting from the external device 300, the control unit 130 stores the second setting in the storage unit 170 to control the each functional unit in the meter monitoring device 100 according to the second setting. In some embodiments, step S416B can be optionally omitted. Accordingly, step S416C can be implemented right after step S416A, but the disclosure should not be limited in this regard.

In step S416C, the control unit 130 is enabled to update the each functional unit in the meter monitor device 100. The control unit 130 updates the setting of each functional unit in the meter monitoring device 100 according to the received second setting. For example, the time of the clock unit 150 is calibrated according to the second setting, and a predetermined time is set for the clock unit 150 to turn on the first switch S1 in the operation mode, such that the clock unit 150 can accurately turn on the first switch S1 at the predetermined time, but the disclosure should not be limited in this regard.

In some embodiment, step S416C can be implemented before step S416B, but the disclosure should not be limited in this regard.

In some embodiment, the external device 300 can be a server installed at the company owning the meter device, such as an electrical power company, a water supply company, or a gas supply company.

With the control method in FIG. 9, the meter monitoring device 100 of the present disclosure can obtain the latest setting from the external device 300 through the communication unit 180, and update the old setting according to the latest setting to meet the user's operation requirements.

In some embodiments, the control unit is a functional unit controlling the multiple functional units in the meter monitoring device 100 to perform the surface 210 monitoring function. In other embodiments, the control unit 130 includes sub-control units that respectively control different functional units in the meter monitoring device 100 to perform the surface 210 monitoring function, but the disclosure should not be limited in this regard.

Accordingly, in the meter monitoring device and the control method thereof of the present disclosure, one or more switches are disposed between the power supply unit and either of the control unit, the image capture unit and the communication unit. With the aforementioned configuration, the specific switch is turned on when it is necessary to allow the power unit to supply electrical power to the specific functional unit, thereby achieving the purpose of electrical power saving. In addition, the meter monitoring device of the present disclosure is detachably attached to the meter devices with various specifications on the market without needing to replace the original meter device, thus avoiding complicated replacement work and greatly saving replacement cost. Furthermore, the meter monitoring device of the present disclosure is able to automatically retrieve new settings from a remote end and automatically update its setting according to the new settings, so as to meet the user's needs.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A meter monitoring device, comprising:
a housing configured to be detachably attached to a meter device;
a power supply unit;
an image capture unit electrically connected to the power supply unit;
a control unit configured to control the image capture unit to capture an image of a surface of the meter device;
a first switch connected between the power supply unit and the control unit, wherein the power supply unit is configured to supply power to the control unit via the first switch; and
a clock unit configured to control the first switch to be turned on according to a setting,
wherein the power supply unit, the control unit, the image capture unit, the first switch, and the clock unit all are fixed to the housing.

2. The meter monitoring device of claim 1, further comprising a second switch, wherein the control unit is configured to control the second switch to be turned on or turned off, and the power supply unit is configured to supply power to the image capture unit via the second switch.

3. The meter monitoring device of claim 1, further comprising a communication unit electrically connected to the control unit and the power supply unit, wherein the communication unit is configured to transmit information to an external device.

4. The meter monitoring device of claim 3, further comprising a second switch, wherein the control unit is configured to control the second switch to be turned on or turned off, and the power supply unit is configured to supply power to the communication unit via the second switch.

5. The meter monitoring device of claim 1, further comprising a main board comprising a plurality of fixed connection sockets, the image capture unit comprising a connection plug, wherein the connection plug is detachably connected to one of the fixed connection sockets.

6. The meter monitoring device of claim 1, further comprising an image identification unit electrically connected to the image capture unit, wherein the image identification unit is configured to identify a character in the image.

7. The meter monitoring device of claim 1, wherein the control unit is configured to control the clock unit to turn off the first switch.

8. A control method for controlling a meter monitoring device attached on a meter device, the meter monitoring device comprising a power supply unit, a control unit, a first switch connected between the power supply unit and the control unit, an image capture unit connected to the control unit, and a clock unit connected to the first switch, the control method comprising:
enabling the clock unit to turn on the first switch according to a first setting, so as to allow the power supply unit to supply power to the control unit via the first switch; and
enabling the control unit to control the image capture unit to capture an image of a surface of the meter device.

9. The control method of claim 8, wherein the meter monitoring device further comprises a second switch connected between the power supply unit and the image capture unit, and the control method further comprises:
enabling the control unit to turn on the second switch, so as to allow the power supply unit to supply power to the image capture unit via the second switch.

10. The control method of claim 8, wherein the meter monitoring device further comprises a communication unit connected to the control unit and the power supply unit, and the control method further comprises:
enabling the control unit to control the communication unit to transmit information to an external device.

11. The control method of claim 10, wherein the meter monitoring device further comprises a second switch connected between the power supply unit and the communication unit, and the control method further comprises:
enabling the control unit to turn on the second switch, so as to allow the power supply unit to supply power to the communication unit via the second switch.

12. The control method of claim 10, further comprising:
enabling the communication unit to receive a second setting from the external device; and
enabling the control unit to update the clock unit according to the second setting, so as to enable the clock unit to turn on the first switch according to the second setting.

13. The control method of claim 12, further comprising:
after updating the clock unit according to the second setting, enabling the control unit to control the clock unit to turn off the first switch, so as to stop the power supply unit from supplying power to the control unit.

14. The control method of claim 8, wherein the meter monitoring device further comprises an image identification unit connected to the image capture unit, and the control method further comprises:
enabling the image identification unit to identify a character in the image.
